(19) United States
(12) Patent Application Publication
(10) Pub. No.: US 2015/0231014 A1
(43) Pub. Date: Aug. 20, 2015

(54) MASSAGE TOOL WITH INTEGRATED TAPE CUTTER

(71) Applicant: Rocktape, Inc., Campbell, CA (US)

(72) Inventors: Steven Capobianco, Highlands Ranch, CO (US); Gregory van den Dries, Los Gatos, CA (US)

(21) Appl. No.: 14/573,510

(22) Filed: Dec. 17, 2014

Related U.S. Application Data
(63) Continuation of application No. PCT/US14/17451, filed on Feb. 20, 2014.

(51) Int. Cl. A61H 1/00; B25F 1/00

(52) U.S. Cl. CPC A61H 1/008; B25F 1/00

(57) ABSTRACT

A hand-held massage tool includes a grip, at least one surface adapted to massage a human body while the massage tool is held using the grip, and a tape cutter. The grip can include one or more openings in the massage tool, a textured portion of the massage tool, or a handle. The massage tool can include a plurality of surfaces adapted to massage a human body, each surface of the plurality of surfaces having a contour to correspond to a portion of a human body and a cross-sectional shape. The tape cutter can include at least one blade coupled to the massage tool having at least one position where the at least one blade is positioned to avoid cutting a finger.

### CROSS-REFERENCE TO RELATED APPLICATIONS

The present application is a continuation of International Patent Application No. PCT/US2014/017451 entitled “Massage Tool with Integrated Tape Cutter” filed on Feb. 20, 2014, the entire contents of which are hereby incorporated by reference in its entirety for any and all purposes.

### BACKGROUND

1. Technical Field

The present subject matter relates to a massage tool, and more particularly, a hand-held manual massage tool with an integrated tool to cut tape.

2. Background Discussion

Massage has long been used as a relaxation technique as well as a form of therapy for fatigue and many different musculoskeletal disorders. Massage involves manipulation of a person's body, and often targets one or more specific muscles and/or joints on the body, depending on the objective of the massage. Targeted tissues for various types of massage include muscles, tendons, ligaments, fascia, skin, lymphatic vessels, and organs of the gastrointestinal system. Many different techniques are used for massage, including static pressure, moving pressure, and vibration.

Different massage techniques are applied using various apparatus. In many types of massage, the masseuse uses a part of their body to apply the massage, such as hands, fingers, elbows, knees, forearms, or feet. In some types of massage, the individual receiving the massage is positioned on an apparatus that positions the individual for the masseuse, or can even apply the massage directly to the individual. The apparatus can vary widely and range from a small object, such as a ball or block, that the individual lays, sits or stands on, to large complex massage machines, such as a massage chair, that hold the individual and mechanically perform the massage on the individual.

In some forms of massage, such as myofascial release, fascial tissue manipulation, Gua sha, and the Graston Technique®, just to name a few, hand-held massage tools are commonly used. In many types of massage, the massage tools are used to stretch the fascia and release bonds between fascia, integument, and muscles, with a goal of eliminating pain and/or increasing a range of motion. The tools can be used to apply shear compression or tension in various directions, to roll over the skin, or for many other effects, depending on the type of massage and the specific objectives.

While it is not usually considered a form of massage, kinesiology tape is often used in conjunction with massage. Kinesiology tape, which is often a cloth-based self-adhesive tape, is a tape with anisotropic stretch properties, so that it is able to stretch much more in one direction, such as the length, than in the other direction, such as width. Kinesiology tape is applied to the individual in a stretched condition to provide a therapeutic benefit to the individual from the recoil effect of the elasticity of the tape. Kinesiology tape can be applied in many different configurations, depending on the tissue group being targeted and the intended effect, but in at least some situations, the tape is applied, in a stretched position, from the origin of the targeted muscle to the insertion point of the muscle. Once the tape has been applied, it is often rubbed to active a pressure-sensitive adhesive. While kinesiology tape is sometimes provided in pre-cut sections for specific taping patterns, it is often provided in a bulk form, such as a roll that allows for individual strips of tape to be cut to an appropriate length as needed.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1 shows an embodiment of a massage tool with an open integrated tape cutter and a removable pick;

FIG. 2A-G show various views of the same massage tool as FIG. 1, but with the tape cutter closed and the removable pick housed in the massage tool;

FIG. 3 shows the massage tool using the integrated tape cutter to cut tape;

FIG. 4A shows one way to hold the massage tool using a hole in the massage tool to facilitate holding the massage tool;

FIG. 4B shows another way to hold the massage tool to perform massage using a surface of the massage tool;

FIG. 4C shows a way of to hold the massage pick to perform massage using a surface of the massage pick;

FIG. 5 shows the massage tool opening a bottle using an integrated bottle opener of the massage tool;

FIG. 6A-B shows an alternative embodiment of a massage tool with an integrated tape cutter;

FIG. 7A-C shows another alternative embodiment of a massage tool with an integrated tape cutter;

FIG. 8A-D shows yet another alternative embodiment of a massage tool with an integrated tape cutter; and

FIG. 9 shows a flow chart of an embodiment of a method of using a massage tool.

### DETAILED DESCRIPTION

In the following detailed description, numerous specific details are set forth by way of examples in order to provide a thorough understanding. However, it should be apparent to those skilled in the art that the some embodiments may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

The common usage of kinesiology tape in conjunction with massage increases the number of tools that are used by a masseuse, therapist, athletic trainer, or an individual treating themselves, to provide both massage and taping services. Several different types of massage tools may be carried, each adapted to massage a particular muscle group or portion of the body. In addition, kinesiology tape of various widths and lengths may be needed, depending on the body part upon which they are affixed and the condition being treated. If pre-cut strips are used, this could mean that a large number of different pre-cut strips need to be carried, and even so, there is always a possibility of needing a strip of a different length, so that even a pre-cut strip could be cut to a shorter length. Because of this, some type of tape cutter, such as scissors of a knife is also often included in the gear kit of the masseuse, therapist, or athletic trainer. And in addition, a bottle opener is also often carried to facilitate access to a favorite adult beverage with friends after a workout.

A massage tool is described herein that has an integrated tape cutter to cut the cloth based kinesiology tape, eliminating the need to carry a separate pair of scissors. The massage tool includes a grip, such as one or more openings or indentations, a handle, or a textured surface, to facilitate holding the massage tool with one or two hands while using the massage tool to massage a part of the human body.

Some embodiments of the massage tool provide multiple different surfaces adapted to massage different portions of the human body. This can potentially reduce the number of massage tools that need to be carried.

Some embodiments of the massage tool include a removable smaller massage tool, such as a massage pick, that can be stored in a pocket within the larger massage tool. The smaller massage tool is designed for purposes that might be difficult to perform with the larger massage tool, such as interdigital massage or massage around bony landmarks of the body.

Some embodiments also incorporate a bottle opener. The bottle opener can be used to open a standard beverage bottle with a crimped-on bottle cap, such as a glass soda pop bottle or glass beer bottle.

Reference now is made in detail to the examples illustrated in the accompanying drawings and discussed below.

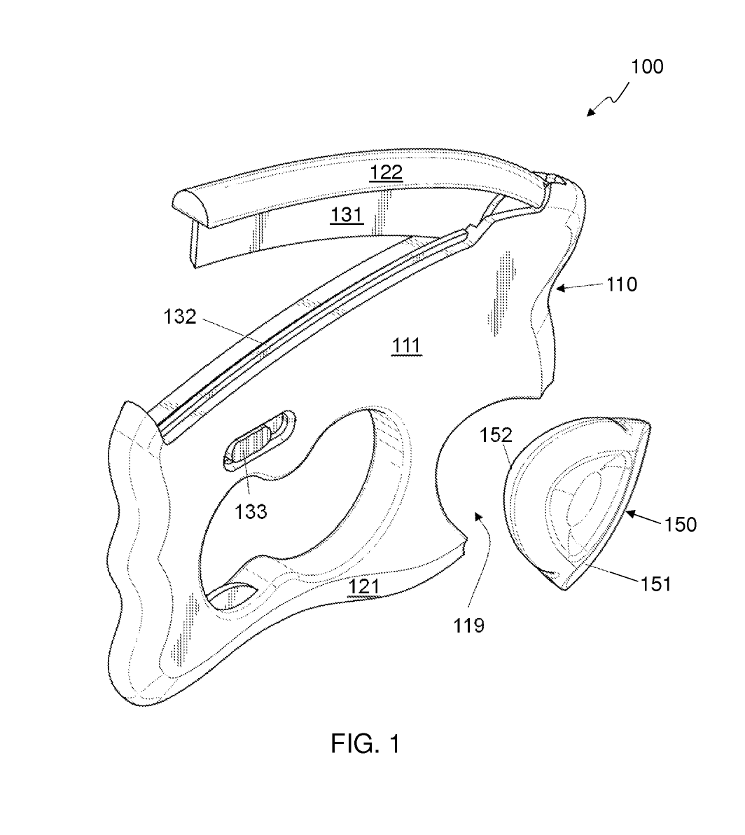

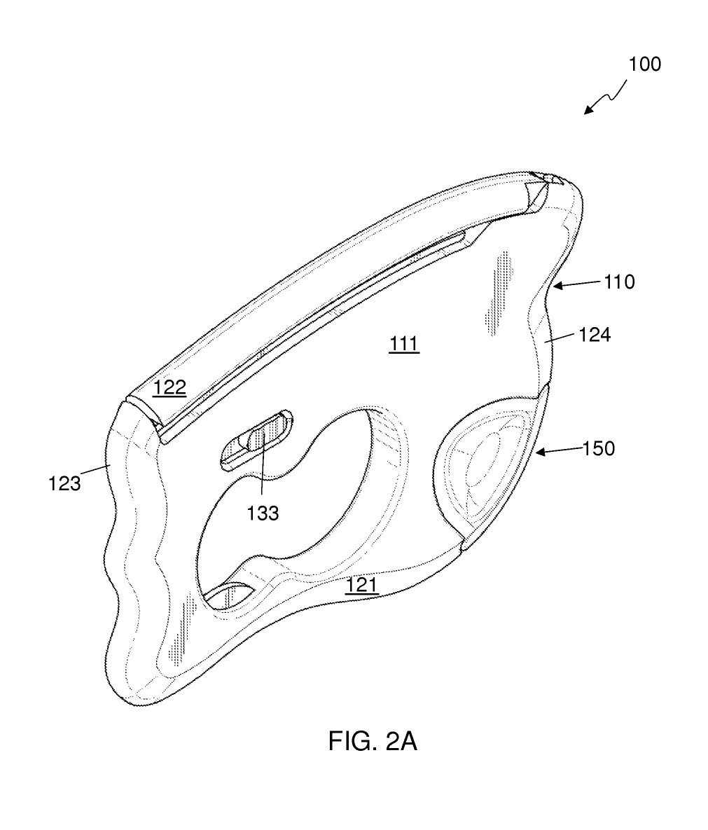

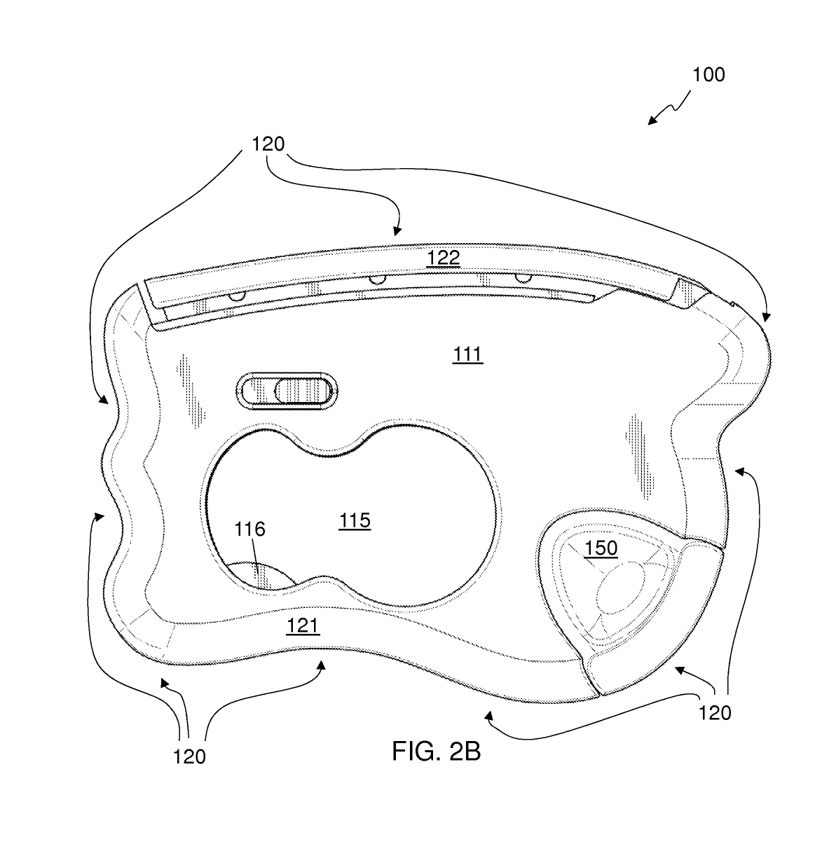

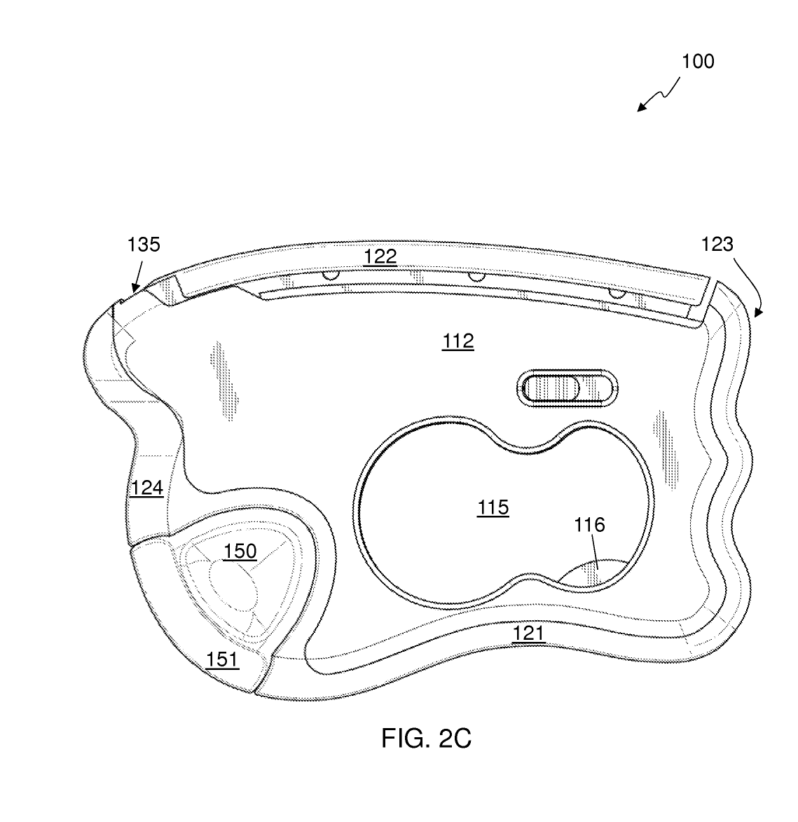

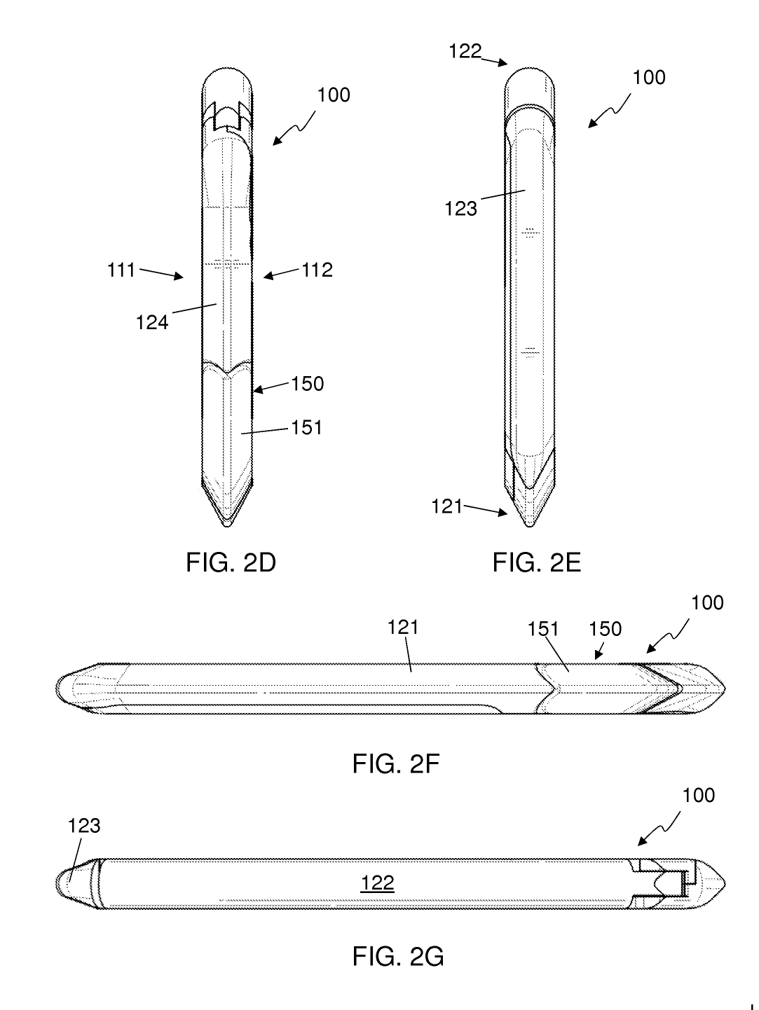

FIG. 1 shows an oblique view of an embodiment of a massage tool 100 with an open integrated tape cutter and a removable pick 150, and FIG. 2A-G show various views of the same massage tool 100, but with the tape cutter closed and the removable pick 150 housed in the body 110 massage tool 100. FIG. 2A shows an oblique view of the massage tool 100. FIG. 2B shows a right side elevation view and FIG. 2C shows a left side elevation view of the massage tool 100. FIG. 2D shows a front elevation view and FIG. 2E shows a rear elevation view of the massage tool 100. FIG. 2F shows a bottom plan view and FIG. 2G shows a top plan view of the massage tool 100. The following discussion applies equally to FIG. 1 and FIG. 2A-G, with various parts of the massage tool 100 shown more clearly in some views than in other views. While common reference numbers are used for these drawings, not every feature is labeled with the reference number in every drawing in which it is visible to help enhance the clarity of the drawings.

The hand-held massage tool 100 includes a body 110 having a first side, or right side 111, a second side, or left side 112, opposite of the first side 111, and a rim 120 therearound. In the embodiment shown, the first side 111 and the second side 112 are substantially flat, although other embodiments may have sides that are convex, concave, or have a more complex shape. The massage tool can be of any thickness, length and height suitable to be held in one or two hands, depending on the embodiment. In at least some embodiments, the body has a thickness between about 5 millimeters (mm) and about 50 mm, with at least one embodiment having a body 110 with a thickness of about 9 mm. In some embodiments, the body has a length and height that are each between about 30 mm and about 300 mm, with at least one embodiment having a body 110 with a length of about 121 mm, and a height of about 83 mm. The body 110 of the massage tool 100 includes an opening 115 therethrough, with a protrusion 116 inside the opening 115 adapted to catch an edge of a bottle cap.

The rim 120 extends around the massage tool 100 and is divided into sections that may be continuous or have discontinuities between sections. Some embodiments have the rim 120 extend fully around the massage tool, but other embodiment, may have portions where there is no rim coupled between the two sides such as the pocket 119 if the massage pick 150 is removed. The rim 120 should be considered to exist therearound even if the rim 120 does not fully extend around the body 110, as long as there is at least one section of the rim 120 that is coupled between the first side 111 and the second side 112. The body 110 and the rim 120 can be made in one or more parts joined together in any fashion, and can be made of any suitable material or materials, including, but not limited to, metals, such as high carbon steel or stainless steel, ceramics, polymers, such as acrylonitrile butadiene styrene (ABS), polycarbonate (PC), polybutylene terephthalate (PBT), polyoxymethylene (POM), nylon, or polyvinyl chloride (PVC), or any combination of materials.

In at least some embodiments, the rim 120 includes a plurality of sections. In the embodiment shown, the rim 120 includes at least a first section 121, a second section 122, a third section 123 and a fourth section 124, as well as a fifth section that is the wide end 151 of the massage pick 150. Some of the sections, such as the first section 121, third section, 123 and fourth section 124 are integral with the body 110. Some sections, such as the second section 122 which is hingedly attached to the body 110, and the fifth section 151 that is the wide end 151 of the massage pick 150, are separate pieces that are coupled to the body by various mechanisms and may be either moveable or fixed, depending on the embodiment. Various embodiments may include any number of sections of the rim 120. Each section of the plurality of sections of the rim 120 has a contour, to correspond to a portion of a human body, and a cross-sectional shape. The contour refers to the curve of the section as seen from one or both sides 111, 112 of the body 110. In at least one embodiment, the body 110, along with the first section 121, the third section 123 and the fourth section 124 of the rim 120 are molded together using a PC+PBT blend. In that embodiment, the massage pick 150 is separately molded using a PC+PBT blend. The second section 122 of the rim 120 in that embodiment is made using nylon.

In some embodiments, the massage tool 100 includes at least one section with a concave contour and at least one section with a convex contour. Some embodiments may include one or more sections with a straight contour. In the embodiment shown, the first section 121 of the rim 120 has a concave contour that may correspond to certain body extremities such as the arm or lower leg. The first section of the rim 121 has a smooth surface and is adapted to manipulate fascial tissue of a human. The second section 122 of the rim 120 has smooth surface with a convex contour that may correspond to larger and/or flatter portions of the body, such as the back or thigh. The word correspond, as used herein, does not necessary mean that the shapes match, but simply that the shape of that section may be adapted to massage that particular body part. The third section 123 and fourth section 124 of the rim 120 have more complex shapes that include subsections, each subsection having a convex or concave contour. The third section 123 also has a smooth surface may be adapted to manipulate fascial tissue of a different portion of the human body than the first section 121, such as around bony structures such as the elbow, or spine.

Each section of the plurality of sections of the rim 120 has a the cross-sectional shape. In some embodiments, the cross section shape of the outer portion of each section is selected from a group consisting of a rounded cross-section having a radius of about half of the thickness of the body 110, such as section 122, a rounded cross-section having a radius of less than about half of the thickness of the body 110, such as the third section 123, and a wedge-shaped cross-section, such as the second section 121. A wedge shaped cross-section has a point having a radius of less than about 1.5 mm and substantially straight sides leading from the point to the body. While no true cross-sectional views are provided in the figures, FIG. 2E shows a profile of the first section 121 and the second section 122, allowing the wedge-shaped cross section and the rounded cross-section with a radius of about half of the thickness of the body, respectively, to be envisioned by one of ordinary skill. FIG. 2G shows a profile of the third section 123, allowing the rounded cross-section with a radius of less than about half of the thickness of the body to be envisioned by one of ordinary skill.

The massage tool 100 includes a second section 122 of the rim 120 hingedly attached to the body 110 and having a first blade 131 fixed thereto. A second blade 132 is fixed to the body 110 adjacent to the second section 122 of the rim 120. The second blade 132 is positioned such that movement of the second section 122 of the rim 120 toward the body 110 causes the first blade 131 to slide over the second blade 132 in a close cutting engagement. The first blade 131 and the second blade 132 act similarly to blades of a scissors. The first blade 131 and the second blade 132 have sharpened edges and are capable of cutting tape, including cloth-based kinesiology tape. The body 110 is configured to allow the first blade 131 to slide next to the second blade 131 as the second section 122 is positioned against the body 110, so that the edges of the first blade 131 and second blade 132 are inaccessible while the second section 122 of the rim 120 is closed against the body 110. Inaccessible, as used herein, means that the edges of the blades 131, 132 are positioned in such a way that it would be difficult or impossible to cut a finger on the blades 131, 132. In some embodiments, a cavity is included the body 110 next to the second blade 131 to hold the first blade 131 while the second section 122 is closed. In other embodiments, the body 110 is cut away between the second blade 132 and the second side 112 to provide a location for the first blade 131 to rest while the second section 122 is closed. Similarly, some embodiments provide a pocket in the second section 122 to allow a place for the second section 122 to hold the second blade 132 while the second section 122 is closed against the body 110. In other embodiments, such as the embodiment shown, the second blade 132 does not extend away from the body 110 far enough to interfere with the second section 122 of the rim 120.

In some embodiments of the massage tool 100, a latch 133 is included. The latch 133 has at least two positions. In the first position, as shown in FIG. 2A, the latch 133 holds the second section 122 closed against the body, keeping the edges of the blades 131, 132 inaccessible. In a second position, as shown in FIG. 1, the latch allows the second section 122 to swing open, away from the body, exposing the edges of the blades 131, 132. Thus, the latch 133 is operable to hold the second section 122 of the rim 120 in a closed position against the body 110, and to alternatively release the second section 122 of the rim 120 and allow the second section 122 of the rim 120 to swing open from the body 110. In some embodiments, the latch 133 catches the second section 122 as it is closed, to that the second section 122 is kept closed until the latch 133 is moved to allow the second section 122 to swing open again. In other embodiments, the latch 133 stays open until it is manually closed again to hold the second section 122 closed. Some embodiments also include a spring 135 to apply an opening force on the second section 122 of the rim 120. Although the spring 135 is not readily visible in the massage tool 100, its location in the massage tool 100 is identified in FIG. 2C.

Some embodiments of the massage tool include a smaller massage tool, such as the massage pick 150, removably embedded in the massage tool 100. In the massage tool 100, the body 110 includes a pocket 119 formed in the body 110. The removable massage pick 150 is configured to fit into the pocket 119. The massage pick 150 and pocket 119 are configured so that the massage pick 150 is positively engaged in the pocket 119, and the massage pick 150 ‘clicks’ into place in the pocket 119. The massage pick 150 is then locked into place in the pocket 119 until a force is applied to remove it. The force required is large enough to keep the massage pick 150 in place through normal movement, but small enough to allow it to be readily pulled out by a human using two fingers to grab the massage pick 150. The massage pick 150 includes a narrow end 152 and a broad end 151, with the pocket 119 configured to accept the massage pick 150 narrow end 152 first. The broad end 151, while the massage pick 150 is inserted into the pocket 119, forms a section of the rim 120. The ends 151, 152 of the massage pick 150 can have any cross-section, but in at least one embodiment, the narrow end 152 has a rounded cross-section, and the broad end 151 has a wedge-shaped cross-section.

FIG. 3 shows an example of the massage tool 100 using the integrated tape cutter to cut tape. The integrated tape cutter includes the body 110 of the massage pick 100, the second section 122 of the rim 120, the first blade 131 fixed to the second section 122 of the rim 120, and the second blade 132, fixed to the body 110. The first blade 131 can be fixed to the second section 122 by any mechanism, including, but not limited to, glue, heat stakes, bolts, screws, rivets or by molding the first blade 131 into the second section 122 of the rim 120. Similarly, the second blade 132 can be fixed to the body 110 by any mechanism, including those described above. The first blade 131 and the second blade 132 can be made from any suitable material capable of holding an edge, including metals, ceramics and polymers, depending on the type of tape to be cut. In at least one embodiment, the blades 131, 132 are made of stainless steel and each have a sharpened edge.

The tape 300 can be in bulk form, such as the roll shown, or can be strips of a longer length that are being cut into shorter lengths. The second section 122 is opened away from the body 110 to expose the edges of the blades 131, 132. A portion 311 of the tape 300 is positioned to extend beyond the blades 131, 132 so that a cut location 310 is aligned between the first blade 131 and the second blade 132. Once the tape 300 has been positioned with the cut location 310 between the blades 131, 132, the second section 122 is closed by swinging the second section 122 toward the body 110. As the second section 122 closes, the first blade 131 slides against the second blade 132 to create a scissoring action. The scissoring action of the first blade 131 coming in close cutting engagement with the second blade 132 cuts the portion 311 from the bulk tape 300 to form a strip of tape as the tape 300 is cut at the cut location 310.

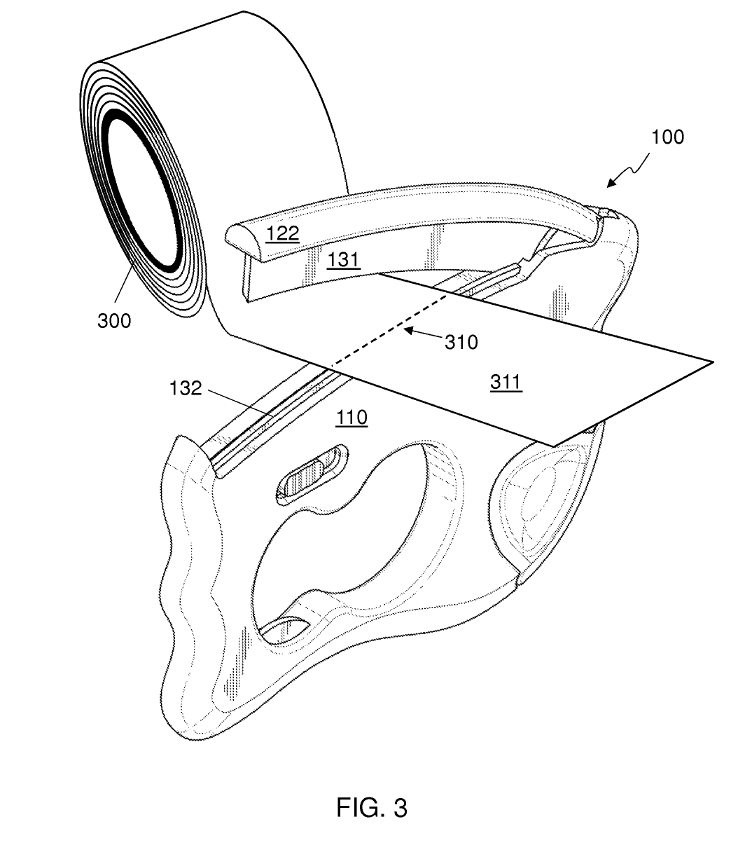

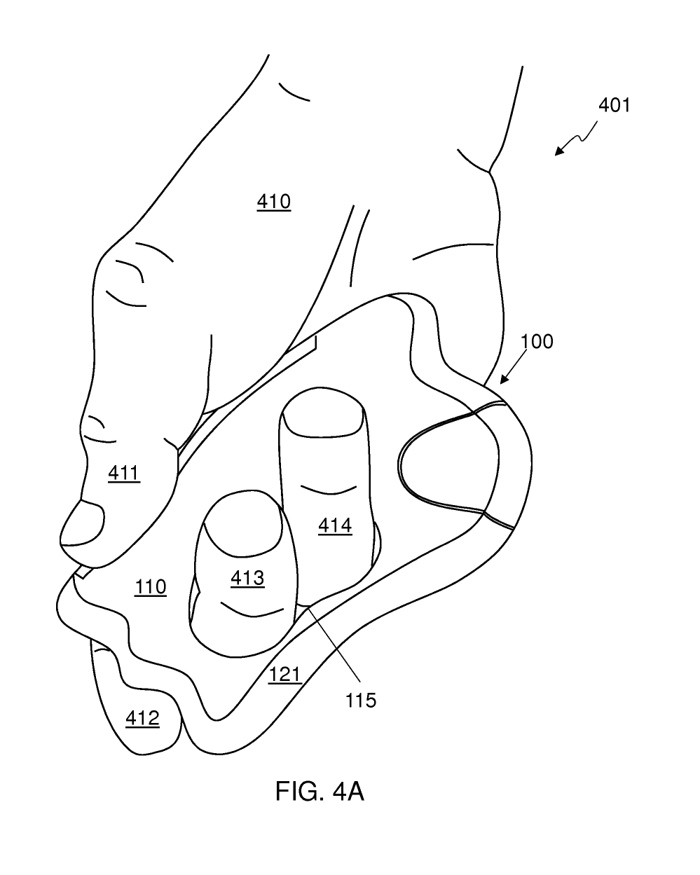

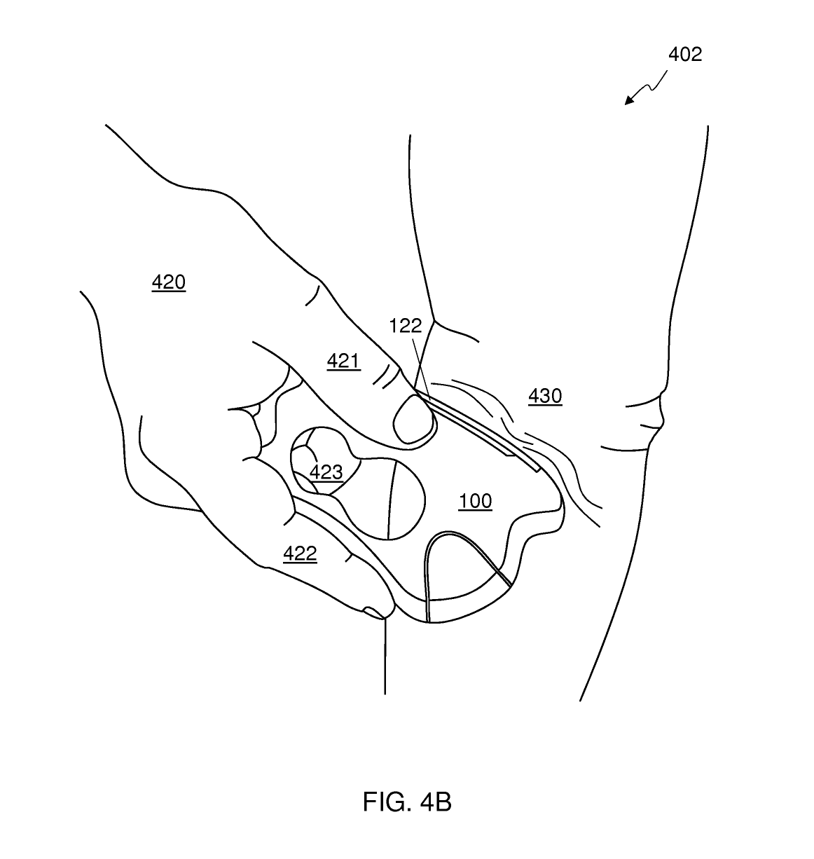

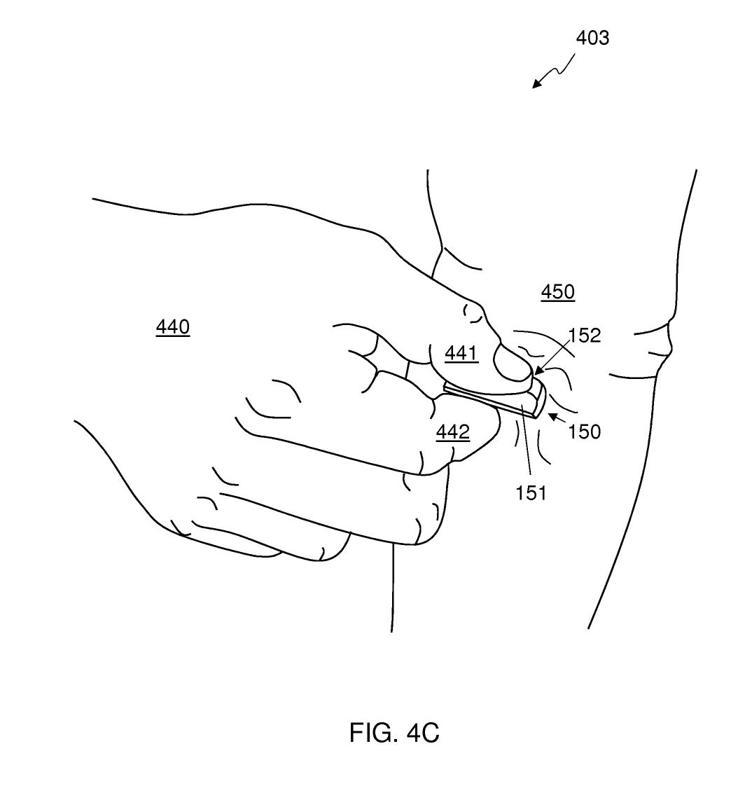

FIG. 4A shows one way to hold 401 the massage tool 100 using a hole 115 in the massage tool 100 to facilitate holding the massage tool 100. The massage tool 100 can be held in many different ways, depending on the masseuse, the surface of the massage tool 100 being applied to the individual, and the type of massage being performed. In the hold 401 shown, one hand 410 is being used to hold the massage tool 100, with one or more fingers, such as the middle finger 413 and ring finger 414 extending through the hole 115 of the massage tool 100 and holding the massage tool 100 against the palm of the hand 410. So an opening 115 through the body 110 sized to allow one or more fingers 412, 414 to protrude through the body 110 can be used to hold the massage tool 100. The thumb 411 and the index finger 412 may be positioned on opposite sides of the massage tool 100 to steady and direct the massage tool 100 as it is used to massage the individual (not shown). In at least some cases, the masseuse can use the massage tool 100 to massage themselves, and may perform self myofacial massage in some cases.

As pictured in FIG. 4A, the first section 121 can be used as a surface to massage the individual. The first surface 121 has a concave contour and a wedge-shaped cross-section and may be used on various portions of the body, including, but not limited to, arms and legs. The massage tool 100 can be used in many different ways. One way that the massage tool 100 can be used while held 401 in this position is to scrape the first section 121 over tissue to assess quality of tissue. The first section 121 may also be used to manipulate fascial tissue. The first section 121 can be used in a scraping motion with the massage tool 100 at an acute angle to the tissue being massaged, or perpendicular to the tissue being massaged, depending on the type of massage being performed. At times, the massage tool 100 is moved against the tissue, but at other times, a static pressure may be applied to the tissue using the massage tool 100.

FIG. 4B shows another way to hold 402 the massage tool 100 to perform massage using a surface of the massage tool 100. One hand 420 is used to hold 402 the massage tool 100, primarily between the thumb 421 and the middle finger 423, with the index finger 422 held against the rim of the massage tool 100 to steady and direct the tool and to provide some force on the tool against the individual being massaged, such as the arm 430 shown. In some cases, the second section 122 is used to manipulate fascial tissue, such a fascial tissue of the arm 430, to improve mobility and function of that tissue. In at least one embodiment, the second surface 122 is used to rub kinesiology tape that has been placed on an individual's body to help activate a pressure sensitive adhesive of the kinesiology tape.

FIG. 4C shows a way of to hold 403 the massage pick 150 to perform massage using a surface of the massage pick 150. The massage pick 150 is held 403 in one hand 440 between the thumb 441 and the index finger 442. While any surface of the massage pick 150 can be used against the tissue of the individual being massaged, in some cases the narrow end 152, which may have a rounded cross-section, is used for interdigital massage, or around bony protrusions such as the elbow of the arm 450. In other cases, the broad end 151, which may have a wedge-shaped cross-section may be applied against tissue for various purposes.

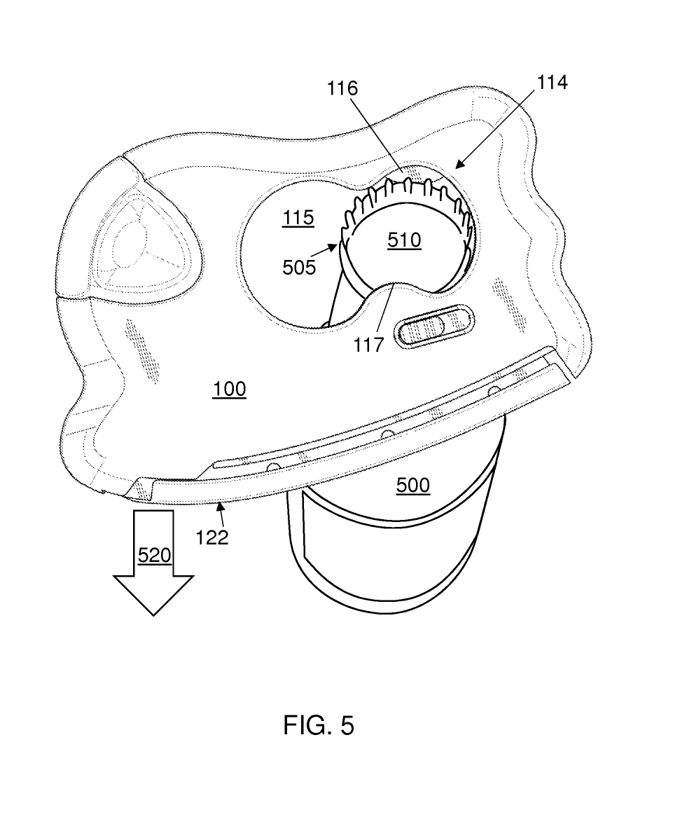

FIG. 5 shows the massage tool 100 opening a bottle 500 using an integrated bottle opener 114 of the massage tool 100. The massage tool 100 includes a bottle opener 114. The bottle opener 114 can be formed using various features of the massage tool 100 that are used for other purposes or included specifically for the bottle opener 114, depending on the embodiment. The bottle opener 114 is formed by including a protrusion 116 on the inside of the opening 115 through the massage tool 100. The protrusion 116 inside the opening 115 is adapted to catch an edge of a bottle cap 510 that is crimped on the lip 505 of the bottle. While the opening 115 is sized to allow one or more fingers to protrude through the body of the massage tool 100, the opening 115 is also is sized to allow one side of the bottle cap 510 to engage with the protrusion 116 while the other side of the bottle cap 510 supports an edge 117 of the opening 115. In some embodiments, the protrusion 116 and the opening are configured so allow one side of the bottle cap 510 to engage with the protrusion 116 while the top of the bottle cap 510 engages with one or more edges 117 of the opening 115. It should be noted that in the embodiment shown, the opening 115 is sized to allow either the fingers to protrude through the opening 115, or to engage with the bottle cap 510, but not both simultaneously. Engaging the bottle cap 510 with the protrusion 116 and the edge 117 of the opening 115 allows the massage tool 100 to pry off the bottle cap 510 of the bottle 500. The prying action is provided by moving the second section 122 down 520 by applying force to the massage tool 100.

So one embodiment of the massage tool 100, as shown in FIG. 1, FIG. 2A-G, FIG. 3, FIG. 4A-C, and FIG. 5, includes a body 110 having a first side 111, a second side 112 opposite of the first side 111, and a rim 120 therearound, where the first side and the second side are substantially flat. The rim 120 includes a plurality of sections of the rim 120, each section of the plurality of sections having a contour adapted to massage a portion of a human body and having cross-sectional shape, with at least one section of the plurality of sections of the rim 120 having a concave contour and at least one section of the plurality of sections of the rim 120 having a convex contour. The cross-sectional shape of an outer portion of each section of the plurality of sections of the rim 120 is selected from a group consisting of a rounded cross-section having a radius of about half of a thickness of the body, a rounded cross-section having a radius of less than about half of the thickness of the body, and a wedge-shaped cross-section. The plurality of sections includes a first section 121 of the rim 120, integral with the body 110, and having a smooth surface and adapted to manipulate fascial tissue of a human. The plurality of sections also includes a second section 122 of the rim 120 hingedly attached to the body 110 and having a first blade 131 fixed thereto. A spring 135 is positioned to apply an opening force on the second section 122 of the rim 120.

A second blade 132 is fixed to the body 110 adjacent to the second section 122 of the rim 120, and movement of the second section 122 of the rim 120 toward the body 110 causes the first blade 131 to slide over the second blade 132 in a close cutting engagement. Edges of the first blade 131 and second blade 132 are inaccessible while the second section 122 of the rim 120 is closed against the body 110. A latch is included, operable to hold the second section 122 of the rim 120 in a closed position against the body 120, and to alternatively release the second section 122 of the rim 120 and allow the second section 122 of the rim 120 to swing open from the body 110 due to the opening force of the spring 135.

The massage tool 100 includes a pocket 119 formed in the body 110, and a removable massage pick 150, having a narrow end 152 and a broad end 151, and configured to fit into the pocket 119. The plurality of sections of the rim 120 includes the broad end 151 of the massage pick 150 while the massage pick 150 is inserted into the pocket 119.

The massage tool 100 includes an opening 115 through the body 110 with a protrusion 116 inside the opening 115 adapted to catch an edge of a bottle cap. The opening 115 is adapted to allow one or more fingers to protrude through the body 110 and to alternatively allow one side of the bottle cap to engage with the protrusion 116 while the other side of the bottle cap supports an edge 117 of the opening 115 to allow the massage tool 100 to pry off the bottle cap of a bottle.

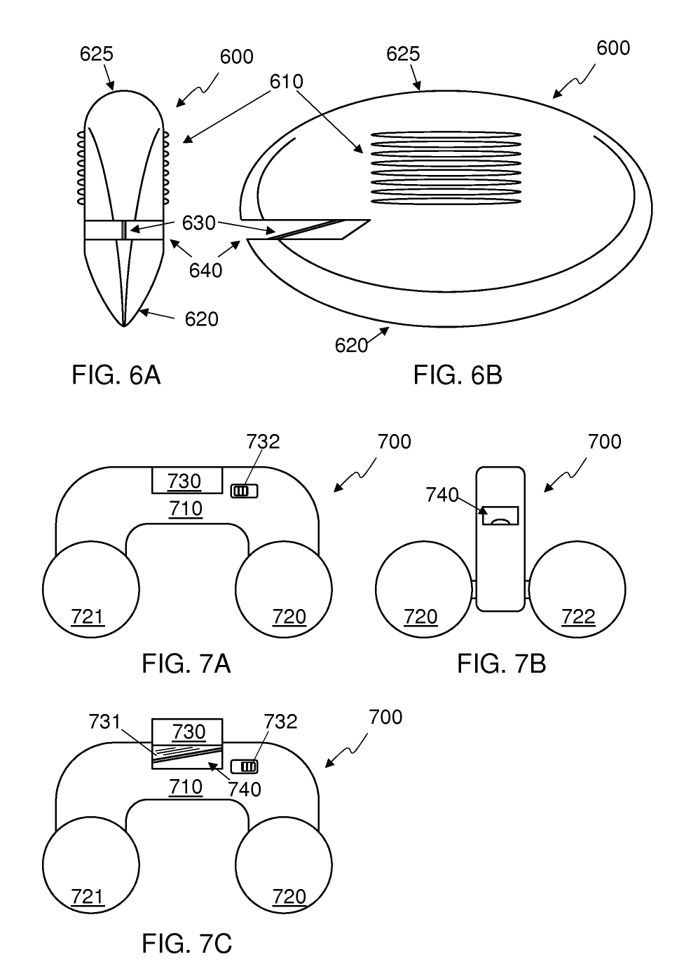

FIG. 6A-B show an alternative embodiment of a massage tool 600 with an integrated tape cutter. FIG. 6A shows an end view of the massage tool 600 and FIG. 6B shows a side view of the massage tool 600. The hand-held massage tool 600 includes at least one gripping feature 610, or grip, to facilitate holding the massage tool 600 with one or two hands. The gripping feature 610 is a textured portion of the massage tool 600, such as raised ridges. The massage tool 600 includes at least one surface 620, 625 adapted to massage a human body while the massage tool 600 is held using the at least one gripping feature 610.

The massage tool 600 includes a tape cutter coupled to the massage tool 600 that includes an opening 640 in the massage tool 600 having a blade 630 positioned therein. The opening 640 may also be sized to function as a bottle opener. Tape can be cut by the tape cutter by sliding an edge of the tape into the opening 640 and against the blade 630. The sharp edge of the blade 630 can cut the tape. The blade 630 is also positioned in the opening 640 in such a way as to make it very difficult or impossible to cut a finger. In some embodiments, a separate cover may be provided to cover the blade 630 during times it is not being used. So the at least one blade 630 has at least one position where the at least one blade 630 is positioned to avoid cutting a finger. An integrated tape cutter is not detachable from the massage tool 600. Although some parts of the tape cutter may be moveable in some embodiments, and in some embodiments, a guard, cover or some part that is not required for the tape cutter to cut tape may be completely removable, the tape cutter itself remains coupled to the massage tool with an integrated tape cutter.

FIG. 7A-C show another alternative embodiment of a massage tool 700 with an integrated tape cutter. FIG. 7A shows a right side view and FIG. 7B shows a front view of the massage tool 700 with the tape cutter 730 in a closed position. The massage tool 700 includes a main body with a handle 710 to facilitate holding the massage tool 700 with one or two hands. The handle 710 may also be referred to as a grip. The massage tool 700 includes four balls, including the right front ball 720, the right rear ball 721 and the left front ball 722, that are rotationally coupled to the massage tool 700 to roll over tissue of an individual as the masseuse holds the massage tool 700 by the handle and moves the massage tool over the individual.

The massage tool 700 includes a tape cutter 730 that is slideably coupled to the massage tool 700, allowing the tape cutter 730 to slide away from the handle 710 of the massage tool 700 to create an opening 740 as shown in FIG. 7C. A first blade 730 is fixed to the tape cutter 730 so that the first blade 730 is moveable coupled to the massage tool 700. One end of tape can be inserted through the opening 740. The tape cutter 730 can then be pushed back toward the handle 710 so that the first blade 730 cuts the tape in a guillotine-like fashion. In some embodiments, a second blade is fixed to a main body of the massage tool, wherein movement of the first blade causes the first blade to slide over the second blade in a close cutting engagement.

The massage tool 700 also includes a latch 732. The latch 732 is operable to release the first blade 731 to move, and to alternatively hold the first blade 731 in a position where an edge of the first blade 731 is inaccessible. In an embodiment having the second blade, the latch 732 is operable to release the first blade 731 to move, and to alternatively hold the first blade 731 in the position where the edges of the first blade 731 and the second blade are inaccessible.

In some embodiments, the massage tool 700 includes a bottle opener 740. The bottle opener 740 can take any form, but may include an opening with a protrusion adapted to catch an edge of the bottle cap.

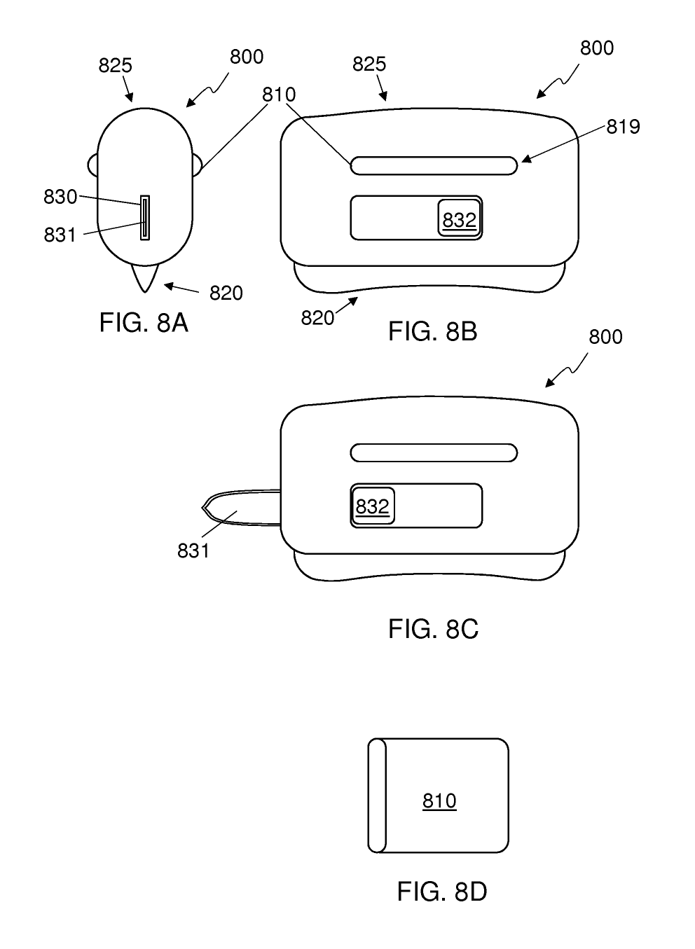

FIG. 8A-D show yet another alternative embodiment of a massage tool 800 with an integrated tape cutter 831. FIG. 8A shows an end view and FIG. 8B shows a side view of the massage tool 800 with the first blade 831 of the integrated tape cutter retracted and the small massage tool 810 inserted into its holder 819 in the massage tool 800. FIG. 8C shows a side view of the massage tool 800 with the first blade 831 of the integrated tape cutter extended. FIG. 8D shows the smaller massage tool 810 removed from its holder 819 in the massage tool 800. The massage tool 800 includes a plurality of surfaces adapted to massage a human body. Each surface of the plurality of surfaces has a contour to correspond to a portion of a human body and a cross-sectional shape. At least one surface 820 has an elongated concave contour and at least one surface 825 has a convex contour. The cross-sectional shape of each surface is selected from a group consisting of a rounded cross-section having a radius of between 4 mm and 25 mm inclusive, such as the convex contoured surface 825, a rounded cross-section having a radius that is less than about 4 mm such as the surfaces of the small massage tool 810, and a wedge-shaped cross-section, such as the concave contoured surface 820. The hand-held massage tool 800 includes at least one gripping feature to facilitate holding the massage tool 800 with one hand, such as the removable smaller massage tool 810 protruding from is pocket 819 in the massage tool 800.

The tape cutter, which includes a first blade 831, has one or more sharp edges and has at least two positions controlled by the latch 832. The latch 832 has a first position where the first blade 831 is refracted into a sleeve 830 in the massage tool 800 and the sharp edges are inaccessible and unable to cut a finger, as shown in FIG. 8A/B. The latch 832 has a second position where the first blade 831 is extended from the sleeve 830 in the massage tool 800 and the sharp edges can be used to cut tape as shown in FIG. 8C. So the latch 832 is operable to release the first blade 831 to cut, and to alternatively hold the first blade 831 in a position where an edge of the first blade 831 is inaccessible.

The massage tool 800 includes a pocket 819 configured to hold a smaller massage tool 810. While the smaller massage tool 810 is inserted in the pocket 819, the smaller massage tool 810 is a part of the massage tool 800 and can also function as a grip, a surface adapted to massage a human body, some other purpose, or any combination thereof. The small massage tool 810 can also be removed from the massage tool 800, as shown in FIG. 8D, and used by itself to massage a human body.

The various embodiments of a hand-held massage tool shown in the figures and described above include at least one gripping feature to facilitate holding the massage tool with one hand, means for massaging a human body while the massage tool is held using the at least one gripping feature, and means for cutting cloth-based tape. In some embodiments, the at least one feature to facilitate holding the massage tool with one hand includes one or more openings in the massage tool, a textured portion of the massage tool, or a handle. Some of the hand-held massage tools include a latch operable to hold the means for cutting cloth-based tape in a position where all sharp edges are inaccessible. Some of the hand-held massage tools also include a bottle opener. Some of the hand-held massage tools include a pocket formed in the massage tool and a removable smaller massage tool configured to fit into the pocket.

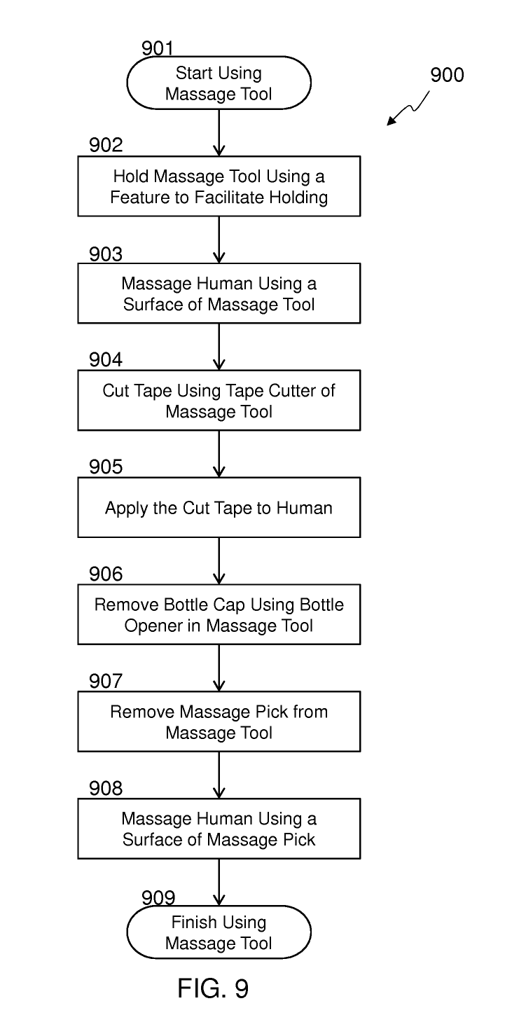

FIG. 9 shows a flow chart 900 of an embodiment of a method for using a massage tool. The method starts at block 901 and continues in some embodiments with holding the massage tool using a gripping feature at block 902. At block 903, the method includes massaging a human using a surface of the massage tool. Any surface of the massage tool can be used for any type of massage on any part of a human. In some cases, one individual can hold the massage tool and massage a part of themselves with the massage tool. In some cases massaging the human includes rubbing a piece of kinesiology tape applied to the human with the surface of the massage tool.

The method continues at block 904 with cutting a piece of tape from bulk tape using a tape cutter integrated with the massage tool. Any type of tape can be cut, but in some cases the tape is cloth tape and in some cases the tape is kinesiology tape. The bulk tape may be a roll of tape or some other piece of tape to be cut. In some cases, the method includes applying the piece of tape to the human being massaged at block 905.

Sometimes, the method includes removing a bottle cap from a bottle using a bottle opener integrated with the massage tool at block 906. In some cases, the method includes removing a smaller massage tool from the massage tool at block 907 and massaging the human with the smaller massage tool at block 908. The massaging may include fascial manipulation. The method concludes at block 909.

It should also be noted that, in some alternative implementations, not all the activities shown are performed and/or the activities noted in the block may occur out of the order noted in the flowchart 900. For example, activities described in two separate blocks may, in fact, be performed substantially concurrently, or the activities described in two separate blocks may be executed in the reverse order. It will also be noted that each block may be performed by one individual, or by different individuals in any combination.

Examples of various embodiments are described in the following paragraphs:

An example hand-held massage tool includes a body having a first side, a second side opposite of the first side, and a rim therearound; a first section of the rim, integral with the body, and having a smooth surface and adapted to manipulate fascial tissue of a human; a second section of the rim hingedly attached to the body and having a first blade fixed thereto; and a second blade fixed to the body adjacent to the second section of the rim. In the example massage tool, movement of the second section of the rim toward the body causes the first blade to slide over the second blade in a close cutting engagement; and edges of the first blade and second blade are inaccessible while the second section of the rim is closed against the body. In some example massage tools the first side and the second side are substantially flat, and the body has a thickness between about one half centimeter and about three centimeters. In some example massage tools the first section of the rim has a concave contour and a wedge-shaped cross-section. In some example massage tools an outer portion of the second section of the rim has a convex contour and a rounded cross-section. Some example massage tools include a third section of the rim having a smooth surface, and a different contour than a contour of the first section of the rim; wherein the first section of the rim is adapted to manipulate fascial tissue of a first portion of a human body; and the third section of the rim is adapted to manipulate fascial tissue of a second portion of the human body. Some example massage tools include a plurality of sections of the rim including the first section and the second section, each section of the plurality of sections having a contour to correspond to a portion of a human body and a cross-sectional shape; wherein at least one section has a concave contour and at least one section has a convex contour; and the cross-sectional shape of an outer portion of each section is selected from a group consisting of a rounded cross-section having a radius of about half of a thickness of the body, a rounded cross-section having a radius of less than about half of the thickness of the body, and a wedge-shaped cross-section. Some example massage tools include a latch operable to hold the second section of the rim in a closed position against the body, and to alternatively release the second section of the rim and allow the second section of the rim to swing open from the body. Some example massage tools include a spring to apply an opening force on the second section of the rim. Some example massage tools include an opening through the body sized to allow one or more fingers to protrude through the body. Some example massage tools include a bottle opener. In some example massage tools, the bottle opener includes a protrusion inside the opening adapted to catch an edge of a bottle cap; wherein the opening is sized to allow an one side of the bottle cap to engage with the protrusion while the other side of the bottle cap supports an edge of the opening to allow the massage tool to pry off the bottle cap of a bottle. Some example massage tools include a pocket formed in the body; and a removable massage pick configured to fit into the pocket. In some example massage tools, the massage pick includes a narrow end; and a broad end; wherein the broad end, while the massage pick is inserted into the pocket, forms a section of the rim. Any combination of the examples of this paragraph may be used in embodiments.

Another example hand-held massage tool includes a grip; at least one surface adapted to massage a human body while the massage tool is held using the grip; and a tape cutter. In some example massage tools, the grip includes one or more openings in the massage tool; a textured portion of the massage tool; or a handle. Some example massage tools include a plurality of surfaces adapted to massage a human body, each surface of the plurality of surfaces having a contour to correspond to a portion of a human body and a cross-sectional shape; wherein at least one surface has an elongated concave contour and at least one surface has a convex contour; and the cross-sectional shape of each surface is selected from a group consisting of a rounded cross-section having a radius of between 4 mm and 25 mm inclusive, a rounded cross-section having a radius of less than 4 mm, and a wedge-shaped cross-section. In some example massage tools, the tape cutter includes at least one blade coupled to the massage tool, wherein the at least one blade has at least one position where the at least one blade is positioned to avoid cutting a finger. In some example massage tools, the tape cutter includes a first blade moveably coupled to the massage tool. Some example massage tools include a latch operable to release the first blade to cut, and to alternatively hold the first blade in a position where an edge of the first blade is inaccessible. Some example massage tools include a second blade fixed to a main body of the massage tool; wherein movement of the first blade causes the first blade to slide over the second blade in a close cutting engagement. Some example massage tools include a bottle opener. Some example massage tools include a pocket formed in the massage tool; and a removable smaller massage tool configured to fit into the pocket. Any combination of the examples of this paragraph may be used in embodiments.

An example method of using a massage tool includes massaging a human using a surface of the massage tool; and cutting a piece of tape from bulk tape using a tape cutter integrated with the massage tool. In some example methods, the massaging the human includes rubbing a piece of kinesiology tape applied to the human with the surface of the massage tool. Some example methods include removing a bottle cap from a bottle using a bottle opener integrated with the massage tool. In some example methods the bulk tape comprises kinesiology tape. Some example methods include applying the piece of tape to the human, removing a smaller massage tool from the massage tool; and massaging the human with the smaller massage tool. In some example methods the massaging comprises fascial manipulation. Any combination of the examples of this paragraph may be used in embodiments.

The description of the various embodiments provided above is illustrative in nature and is not intended to limit the invention, its application, or uses. Thus, different variations beyond those described herein are intended to be within the scope of the embodiments of the present invention. Such variations are not to be regarded as a departure from the intended scope of the present invention. As such, the breadth and scope of the present invention should not be limited by the above-described exemplary embodiments, but should be defined only in accordance with the following claims and equivalents thereof.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing various principles of the present disclosure. Recitation of numerical ranges by endpoints includes all numbers subsumed within that range (e.g. 1 to 5 includes 1, 2.78, π, and 5).

As used in this specification and the appended claims, the singular forms “a”, “an”, and “the” include plural referents unless the content clearly dictates otherwise. Thus, for example, reference to an element described as “an opening” may refer to a single opening, two opening, or any other number of openings. As used in this specification and the appended claims, the term “or” is generally employed in its “and/or” inclusive sense, which includes the case where all the elements are included, unless the content clearly dictates otherwise. As used herein, the term “coupled” includes direct and indirect connections. Moreover, where first and second devices are coupled, intervening elements including active elements may be located there between.

Any element in a claim that does not explicitly state “means for” performing a specified function, or “step for” performing a specified function, is not to be interpreted as a “means” or “step” clause as specified in 35 U.S.C. §112(f).

The description of the various embodiments provided above is illustrative in nature and is not intended to limit the present invention, its application, or uses. As such, the breadth and scope of the present invention should not be limited by the above-described embodiments, but should be defined only in accordance with the following claims and equivalents thereof.

What is claimed is:

1. A hand-held massage tool comprising:
a body having a first side, a second side opposite of the first side, and a rim therearound;
a first section of the rim, integral with the body, and having a smooth surface and adapted to manipulate fascial tissue of a human;
a second section of the rim hingedly attached to the body and having a first blade fixed thereto; and
a second blade fixed to the body adjacent to the second section of the rim;
wherein movement of the second section of the rim toward the body causes the first blade to slide over the second blade in a close cutting engagement; and
edges of the first blade and second blade are inaccessible while the second section of the rim is closed against the body.

2. The massage tool of claim 1, further comprising:
an opening through the body sized to allow one or more fingers to protrude through the body.

3. The massage tool of claim 2, further comprising a bottle opener, the bottle opener comprising:
a protrusion inside the opening adapted to catch an edge of a bottle cap;
wherein the opening is sized to allow an one side of the bottle cap to engage with the protrusion while the other side of the bottle cap supports an edge of the opening to allow the massage tool to pry off the bottle cap of a bottle.

4. The massage tool of claim 1, further comprising:
a pocket formed in the body; and
a removable massage pick configured to fit into the pocket.

5. A hand-held massage tool comprising:
a grip;
at least one surface adapted to massage a human body while the massage tool is held using the grip; and
a tape cutter.

6. The massage tool of claim 5, wherein the grip comprises one or more openings in the massage tool, a textured portion of the massage tool, or a handle.

7. The massage tool of claim 5, further comprising a plurality of surfaces adapted to massage a human body, each surface of the plurality of surfaces having a contour to correspond to a portion of a human body and a cross-sectional shape;
wherein at least one surface has an elongated concave contour and at least one surface has a convex contour; and
the cross-sectional shape of each surface is selected from a group consisting of a rounded cross-section having a radius of between 4 mm and 25 mm inclusive, a rounded cross-section having a radius of less than 4 mm, and a wedge-shaped cross-section.

8. The massage tool of claim 5, wherein the tape cutter comprises:
at least one blade coupled to the massage tool, wherein the at least one blade has at least one position where the at least one blade is positioned to avoid cutting a finger.

9. The massage tool of claim 5, wherein the tape cutter comprises:
a first blade moveably coupled to the massage tool.

10. The massage tool of claim 9, further comprising:
a latch operable to release the first blade to cut, and to alternatively hold the first blade in a position where an edge of the first blade is inaccessible.

11. The massage tool of claim 9, further comprising:
a second blade fixed to a main body of the massage tool;
wherein movement of the first blade causes the first blade to slide over the second blade in a close cutting engagement.

12. The massage tool of claim 5, further comprising:
a bottle opener.

13. The massage tool of claim 5, further comprising:
a pocket formed in the massage tool; and
a removable smaller massage tool configured to fit into the pocket.

14. A method for using a massage tool, the method comprising:
massaging a human using a surface of the massage tool; and
cutting a piece of tape from bulk tape using a tape cutter integrated with the massage tool.

15. The method of claim 14, wherein the massaging the human comprises:
rubbing a piece of kinesiology tape applied to the human with the surface of the massage tool.

16. The method of claim 14, further comprising:
removing a bottle cap from a bottle using a bottle opener integrated with the massage tool.

17. The method of claim 14, wherein the bulk tape comprises kinesiology tape.

18. The method of claim 14, further comprising:
applying the piece of tape to the human.

19. The method of claim 14, further comprising:
removing a smaller massage tool from the massage tool; and
massaging the human with the smaller massage tool.

20. The method of claim 14, wherein the massaging comprises fascial manipulation.
